(19) United States
(12) Patent Application Publication
(10) Pub. No.: US 2016/0018840 A1
(43) Pub. Date: Jan. 21, 2016

(54) METHOD FOR PERFORMING A SWITCHING PROCESS IN AN ON-LOAD TAP CHANGER

(71) Applicant: MASCHINENFABRIK REINHAUSEN GMBH, Regensburg (DE)

(72) Inventor: Thomas STROF, Gumpoldskirchen (AT)

(21) Appl. No.: 14/772,021

(22) PCT Filed: Mar. 21, 2014
(86) PCT No.: PCT/EP2014/055733

§ 371 Date: Sep. 1, 2015

(30) Foreign Application Priority Data
Apr. 4, 2013 (DE) 10 2013 103 360.1

(51) Int. Cl. G05F 5/00

(52) U.S. Cl. CPC G05F 5/00

(57) ABSTRACT

The invention relates to a method for performing a switching process in an on-load tap changer between winding taps of a tapped transformer. The switching process for an on-load tap changer is subdivided into a plurality of phases according to the reactor switching principle. In these phases, the switching contacts in use are monitored during the actuation and are completely opened or closed by capacitors in the controller in the event of failure of the energy supply. Thereby critical switching states are prevented.

The invention relates to a method of switching an on-load tap changer between winding taps of a tapped transformer.

On-load tap changers have been in worldwide use in large numbers for many years for uninterrupted switching between different winding taps of tapped transformers. So-called reactor changers, which are widespread particularly in North America, comprise a switching reactance enabling a slow, continuous switching. On-load tap changers according to the resistance rapid-switching principle usually consist of a selector for power-free selection of the respective winding tap of the tapped transformer which is to be switched over to and a load changeover switch for the actual switching from the previous to the new, preselected winding tap. The load changeover switch for that purpose usually comprises switching contacts and resistance contacts. The switching contacts then serve for direct connection of the respective winding tap with the load diverter and the resistance contacts for temporary connection, i.e. bridging over by one or more switch-over resistances. However, developments in recent years have led away from load changeover switches with mechanical switching contacts in insulating oil. Instead, increasing use is made of vacuum switching cells as switching elements.

An on-load tap changer with vacuum interrupters is known from, for example, DE 10 2009 043 171 [U.S. Pat. No. 9,030,175]. Here, a load changeover switch carries a drive shaft, which is drivable by a force-storing unit, with at least one cam disc. The cam disc has a plurality of cams, wherein two cams arranged on the cam disc at the end have a contour, which departs from a circular shape, in the manner of lobes at which a respective roller connected with a vacuum interrupter by a rocker lever is guided under maintained contact, which roller tracks the profiled contour of the respective cam.

Due to the constructional configuration of this on-load tap changer this requires a spring force-storing unit for abrupt switching by the contact system. Force-storing units known from the prior art are pulled up, i.e. stressed, by a drive shaft at the start of each actuation of the on-load tap changer. The known force-storing units essentially consist of a pull-up carriage and a jump carriage, between which energy storage springs as force-storing unit are arranged.

Force-storing units of that kind are evident from, for example, DE 198 55 860 and DE 28 06 282 [GB 2014794]. Despite these force-storing units used over decades there is repeated failure of these devices. Since the on-load tap changer is in use over a lengthy period of time the compression or tension springs repeatedly break and thus prevent switching. Moreover, it can happen that a carriage does not reach the end position, the switching shaft thus does not completely rotate and the switching contacts do not reach the end position thereof. In the worst case this can lead to destruction of the entire tapped transformer.

By comparison with the prior art, the latest on-load tap changer models of the applicant do not have a mechanical force-storing unit for performance of switching processes. Actuation takes place directly by an electric drive. In the event of sudden failure of the energy supply for such a drive during a switching process, however, critical settings in the on-load tap changer can arise. These are, in particular, shortly before closing or after opening of a switching contact. In that case, it is possible, for example, for welding of the contacts in the interior of the vacuum interrupter to occur.

The object of the invention is thus to provide a method of switching an on-load tap changer in order to thereby increase the reliability of on-load tap changers.

This object is fulfilled by a method with the features of the first patent claim. The subclaims relate to particularly advantageous developments of the method.

The general inventive idea in that case consists—in a method of carrying out a switching process of an on-load tap changer—of dividing the switching sequence on which the switching process is based into a plurality of phases, identifying critical and non-critical switching states of the respectively used switching contacts, monitoring each of these phases during a switching process and, in dependence on a decision logic which is parameterized in a controller, processing the value of the supply voltage, which is detected by a voltage monitoring device at the start of an intended switching process, as a decision basis and starting the switching process or entering the next defined phase of the switching process only if a supply voltage is detectable, and in addition, in the case of a voltage drop of the mains or supply voltage and thus in the case of failure of the energy supply of the electric drive during a switching process, overcoming the respective critical switching states, which are identified for a switching sequence, of the respective switching contacts with the help of the energy present in the capacitors of the control in that switching onwards to the succeeding phase, which is identified as non-critical, of the switching states is carried out.

According to the invention, in that case after initiation of the switching to the first phase it is checked by a voltage monitoring device whether a voltage is present at a selected phase line. If a voltage is not present, the switching is broken off and is continued when voltage is present.

During the second phase of the method according to the invention an electric drive is actuated by a control and in that case opens the second switching contact. During the opening, the energy supply of the electric drive is monitored by a controller. In the case of a voltage drop at the energy supply of the electric drive, energy from the capacitors of the control is used for full opening of the second switching contact. Subsequently, thus during the third phase, movement to an adjacent winding tap by a second selector contact is carried out.

During the fourth phase of the method according to the invention the electric drive is actuated by a control and in that case the second switching contact closed. During the closing, the energy supply of the electric drive is monitored by the controller and in the case of voltage drop of the energy supply of the electric drive the energy from capacitors of the control is used for full closing of the second switching contact.

During the fifth phase of the method according to the invention the first selector contact is in contact with a winding tap and the second selector contact is in contact with the adjacent winding tap. The first and second switching contacts are in that case closed. During this time a circular current Ik arises.

During the sixth phase of the method according to the invention it is checked, before continuation of switching, by the voltage monitoring device whether a voltage is present at a selected phase line. If a voltage is not present, the switching is broken off; if voltage is present it is continued. During the seventh, following phase an adjacent winding tap is moved to by the first selector contact.

During the eighth phase of the method according to the invention the electric drive is actuated by a control and the first switching contact closed. During the closing, the energy supply of the electric drive is monitored by a controller and in the case of a voltage drop at the energy supply of the electric drive the energy from capacitors of the control is used for full closing of the first switching contact. The switching is concluded in the ninth phase.

The method according to the invention shall be explained in more detail by example in the following, in which:

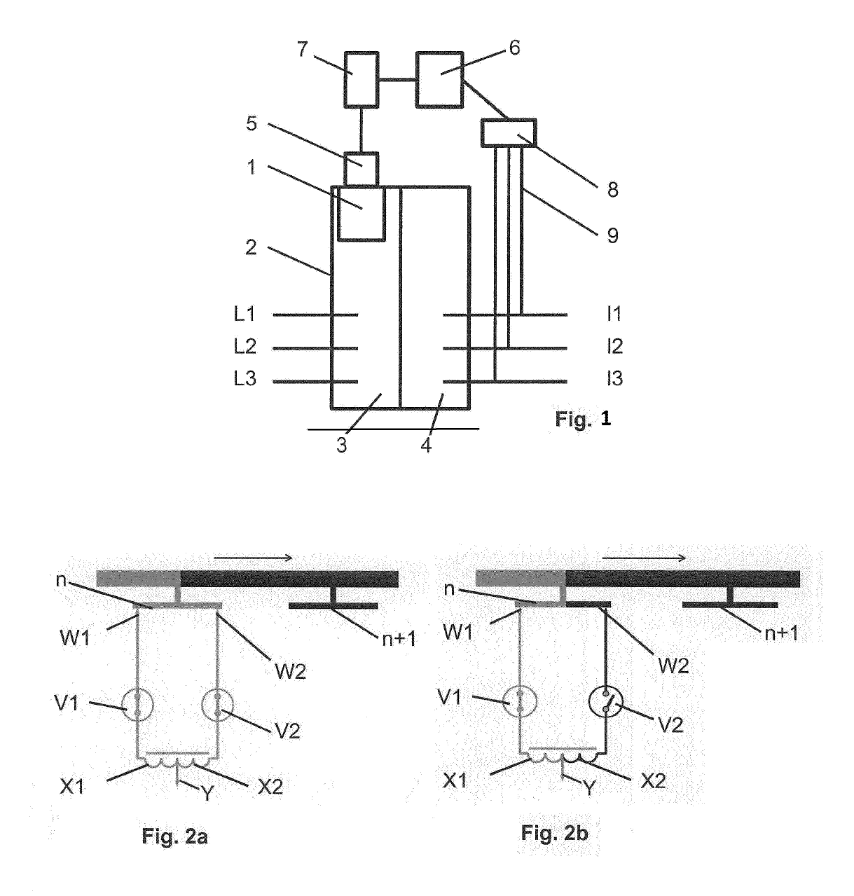

FIG. 1 shows a schematic view of an on-load tap changer with necessary means for performance of the switching process in which critical settings are avoided,

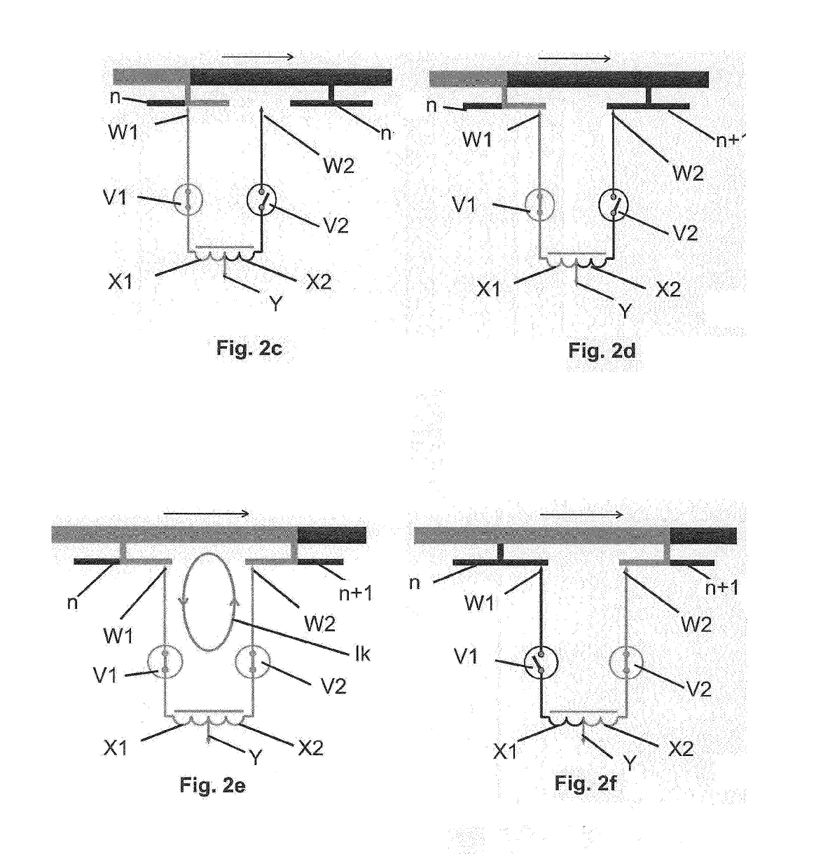

FIGS. 2a-2i illustrate an exemplifying switching process of an on-load tap changer operating according to the reactor switching principle and

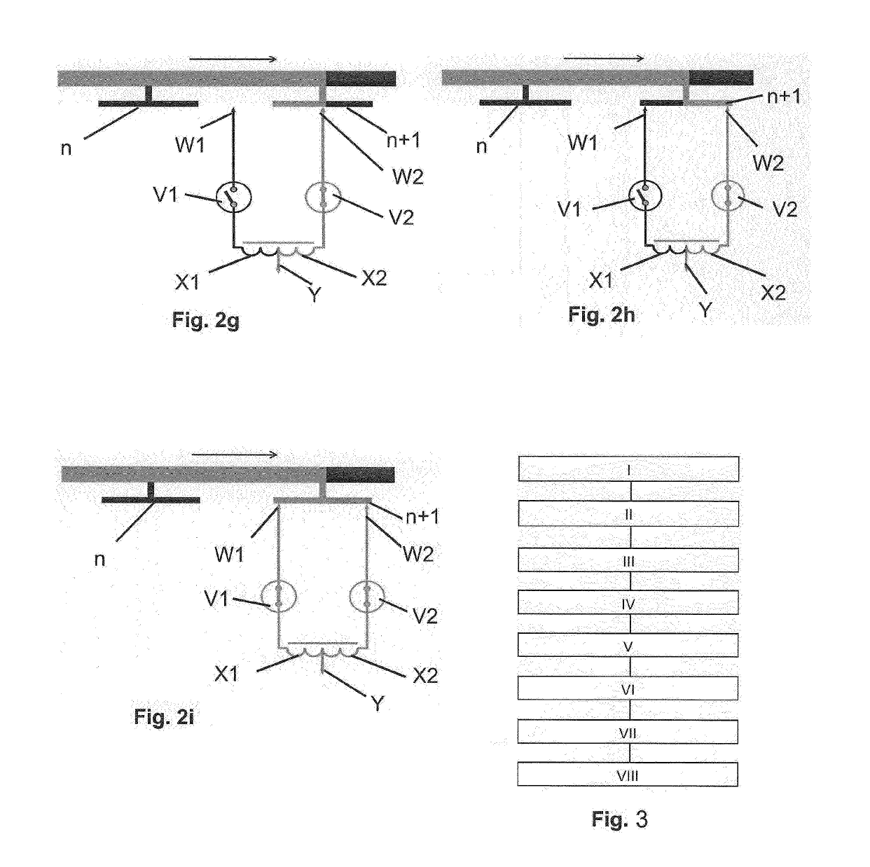

FIG. 3 shows a schematic flowchart with different phases during a switching process.

An on-load tap changer 1, which is present in a tapped transformer 2, according to the reactor switching principle is illustrated in FIG. 1. The tapped transformer 2 has a high-voltage side 3, at which the on-load tap changer 2 is arranged, and a low-voltage side 4. Both the high-voltage side 3 and the low-voltage side 4 each have three respective phase lines L1, L2, L3, I1, I2, I3. The on-load tap changer 1 is actuated by an electric drive 4. A control 6 initiates the individual switching actions of the electric drive 5. The control 6 is connected with the electric drive 5 and with a voltage monitoring device 8, termed SUV 8 in the following, by a controller 7. The SUV 8 monitors the voltage of the individual phase lines I1, I2 and I3 on the low-voltage side 4. The energy supply of the electric drive 5 takes place by one of these phase lines I1 of the low-voltage side 4 via a line 9. However, any of the phase lines I1, I2 and I3 present on the low-voltage side 4 is suitable for that purpose.

Buffer capacitors which are in a position of storing a defined amount of energy are arranged in the interior of the control 6. These are often components of the control 6, but can also be retrofitted subsequently. On initiation of a switching process of the on-load tap changer 1, from a tap n by an intermediate step n+½ to a next tap n+1 of the tapped transformer, the energy from a phase line I1, I2 or I3 is used for the purpose of opening or closing the switching contacts V1, V2, particularly vacuum interrupters, present in the interior of the on-load tap changer 1. The critical settings arise in this switching process particularly in the case of so-called hard opening or hard closing of the switching contacts. Hard opening or closing arises when the contacts are under load, i.e. conduct current. In that case, arcs, which have an effect on the service life of the contacts and in the case of a longer period of burning can even lead to destruction, arise in the interior of the switching contacts.

An exemplifying switching process of an on-load tap changer 1 operating in accordance with the reactor switching principle is illustrated in FIGS. 2a-2i. The on-load tap changer 1 consists of a first switching contact V1 and a second switching contact V2, a first movable selector contact W2 and a second movable selector contact W2, as well as a first switching reactance X1 and a second switching reactance X2. In addition, a load diverter Y is arranged between the first and second reactances X1 and X2. The switching process takes place from a first tap n of a tap winding to an adjacent, second winding tap n+1 of a tap winding of a tapped transformer 2, wherein an intermediate setting n+½ is permissible as a static operational setting.

At the start of a switching process, FIG. 2b, the second switching contact V2 is opened so that the second selector contact W2 can initially be detached free of current from the winding tap n. Subsequently, FIG. 2c, the selector contact W2 moves to the second tap n+1. After reaching the second winding tap n+1, FIG. 2d, the switching contact V2 is closed. In that case, the so-called circular current Ik arises, FIG. 2e. The reactances X1 and X2 make it possible for the on-load tap changer 1 to remain in this position. This setting is termed intermediate step n+½. After opening of the first vacuum interrupter V1, FIG. 2f, the circular current Ik is interrupted and the first selector contact W1 moves in the direction of the second winding tap n+1, FIG. 2g. As soon as the first selector contact W1 has reached the winding tap n+1, FIG. 2h and FIG. 2i, the first switching contact V1 is closed.

According to the invention this switching process can thus be divided into nine phases. In the first phase (I) (FIG. 2a), the switching is initiated. In the second phase (II) the second switching contact V2 is opened. In the third phase (III) (FIG. 2c) the adjacent, second winding tap n+1 is moved to by the second selector contact W2. In phase four (IV), the second switching contact V2 is closed. In phase five (V) (FIG. 2d) both switching contacts V1 and V2 are closed. In phase six (V1) the first switching contact V1 is opened. In phase seven (VII) (FIG. 2g) the first selector contact W1 moves to the adjacent, second winding tap n+1. In phase eight (VIII) the first switching contact V1 is closed. In phase nine (IX) the switching process is ended.

The method according to the invention is illustrated in FIG. 3 by a schematic flowchart. In that case, on initiation of the switching process in the first phase (I) it is initially checked by the SUV 8 whether a voltage is present at the phase line I1, I2, I3 selected for the energy supply. If this not the case, the switching process is not continued and the on-load tap changer 1 remains in this position or the entire tapped transformer 2 is switched off. If a voltage is present, the electric drive 5 is actuated by the control 6.

During this second phase (III) the second switching contact V2 is opened. This phase is regarded as a critical switching state, since non-quenching of the arc can occur if the second switching contact V2 is not fully opened. The controller 7 during this time monitors the energy supply of the electric drive 5. If during this phase (II) a voltage drop, thus failure of the energy supply, occurs this is detected by the controller 7 and compensation is provided with the help of the energy, which is present in the control 6, from the already previously charged capacitors, i.e. the second switching contact V2 is fully opened.

When the opening is completely concluded, the adjacent tap n+1 is moved to by the second selector contact W2 in the third phase (III). During closing of the second switching contact V2, thus in phase four (IV), the energy supply is monitored by the controller 7. This phase (IV) is similarly regarded as a critical switching state, since pre-ignition and subsequent non-quenching of the arc can occur if the second switching contact V2 is not completely closed. In the case of a voltage drop, thus failure of the energy supply, this is detected by the controller 7 and compensation is provided with the help of the energy, which is present in the control 6, from the already previously charged capacitors, i.e. the second switching contact V2 is fully closed. In the fifth phase (V), thus after the second switching contact V2 was closed, the so-called circular current lk arises. This switching state is non-critical.

Prior to opening of the first switching contact V1, thus phase six (VI), it is checked again whether a voltage is present at the phase line I1, I2, I3 selected for energy supply. If this is not the case, the switching process is not continued and the on-load tap changer remains in this position or the entire tapped transformer is switched off. In phase seven (VII) the adjacent winding tap n+1 is moved to. In the eighth phase (VIII) the first switching contact V1 is closed. During this time the controller 7 monitors the energy supply of the electric drive 5. If during this phase a voltage drop, thus failure of the energy supply, occurs this is detected by the controller 7 and compensation is provided with the help of the capacitors present in the control 6 and already previously charged. The switching process is concluded in the last phase.

With the help of the method according to the invention it is always ensured that the first and second switching contacts V1 and V2 never adopt a critical switching state during a switching process of an on-load tap changer 1 from a winding tap n to a next winding tap n+1. Thus, destruction of the switching contacts V1 and V2, the on-load tap changer 1 or even the entire tapped transformer 2 is prevented. This would have disastrous effects on an energy supply mains.

Phases of the switching

| | |
|---|---|
| I | initiation of switching |
| | checking the voltage of a selected phase line by SUV |
| | carrying out switching when voltage is present |
| | breaking-off the switching when the voltage is not present |
| II | actuating the electric drive by a control |
| | opening the second switching contact |
| | monitoring the voltage by a controller |
| | using the energy of the capacitors from the control, in the case of |
| | voltage drop, for full opening of the second switching contact |
| III | movement to the adjacent winding tap by the second selector |
| | contact |
| IV | actuation of the electric drive by a control |
| | closing the second switching contact |
| | monitoring the voltage by a controller |
| | using the energy of the capacitors from the control, in the case of |
| | voltage drop, for full closing of the second switching contact |
| V | maintenance with fully closed switching contacts |
| | creation of the circular current |
| | checking the voltage of a selected phase line by SUV |
| | performing the switching when voltage is present |
| | breaking-off the switching when voltage is not present |
| VI | actuating the electric drive by a control |
| | opening the first switching contact |
| | monitoring the voltage by a controller |
| | using the energy of the capacitors from the control, in the case of |
| | voltage drop, for full opening of the first switching contact |
| VII | movement to the adjacent winding tap by the first selector contact |
| VIII | actuation of the electric drive by a control |
| | closing the first switching contact |
| | monitoring the voltage by a controller |
| | using the energy of the capacitors from the control, in the case of |
| | voltage drop, for full closing of the first switching contact |
| IX | concluding the switching |

1. A method of switching an on-load tap changer between winding taps of a tapped transformer by switching contacts, wherein:
the switching process is divided into a plurality of phases,
critical and non-critical switching states of the respectively used switching contacts are identified,
each of these phases is monitored,
at the start of an intended switching process a value of the supply voltage as a decision basis is detected by a voltage monitoring device in dependence on a decision logic parameterized in a controller and switching to the next defined phase of the switching process is carried out only if the supply voltage is present, and
in the case of a voltage drop in the mains or supply voltage and thus in the case of failure of the energy supply of the electric drive during a switching process, the respective critical switching states, which are identified for a switching sequence, of the respective switching contacts are overcome with the help of the residual energy present in the capacitors of the control in that switching onwards to the succeeding phase, which is identified as non-critical, of the switching states is carried out.

2. The method according to claim 1, wherein after initiation of switching to the first phase a voltage monitoring device checks whether a voltage is present at a selected phase line,
the switching is broken off if a voltage is not present and
the switching is continued if voltage is present.

3. The method according to claim 1, wherein during the second phase an electric drive is actuated by a control and in that case the second switching contact opened,
during the opening the energy supply of the electric drive is monitored by a controller and
in the case of a voltage drop at the energy supply of the electric drive energy from capacitors of the control is used for full opening of the second switching contact.

4. The method according to claim 1, wherein during the third phase an adjacent winding tap is moved to by a second selector contact.

5. The method according to claim 1, wherein during the fourth phase the electric drive is actuated by a control and in that case closes the second switching contact,
the energy supply of the electric drive is monitored by the controller during the closing and
in the case of a voltage drop at the energy supply of the electric drive energy from capacitors of the control is used for full closing of the second switching contact.

6. The method according to claim 1, wherein during the fifth phase a first selector contact contacts a winding tap and the second selector contact contacts the adjacent winding tap,
the first and second switching contacts are closed and
in that case a circular current Ik arises.

7. The method according to claim 1, wherein during the sixth phase the voltage monitoring device checks before continuing the switching whether a voltage is present at a selected phase line,
the switching is broken off if a voltage is not present and
the switching is continued if voltage is present.

8. The method according to claim 1, wherein during the seventh phase an adjacent winding tap is moved to by the first selector contact.

9. The method according to claim 1, wherein during the eighth phase the electric drive is actuated by a control and in that case closes the first switching contact,
the energy supply of the electric drive err is monitored by a controller during the closing and
in the case of a voltage drop at the energy supply of the electric drive energy from capacitors of the control is used for full closing of the first switching contact.

10. The method according to claim 1, wherein in the ninth phase the switching is concluded.
